(19) United States
(12) Patent Application Publication
(10) Pub. No.: US 2026/0012874 A1
(43) Pub. Date: Jan. 8, 2026

(54) METHODS, ARCHITECTURES, APPARATUSES AND SYSTEMS FOR MEASUREMENT REPORTING AND CONDITIONAL HANDOVER

(71) Applicant: InterDigital Patent Holdings, Inc., Wilmington, DE (US)

(72) Inventors: Oumer Teyeb, Montreal (CA); Yugeswar Deenoo Narayanan Thangaraj, Chalfont, PA (US); Filipe Conceicao, London (GB); James Miller, Northport, NY (US); Tezcan Cogalan, London (GB)

(21) Appl. No.: 19/100,670

(22) PCT Filed: Aug. 1, 2023
(86) PCT No.: PCT/US2023/029181

§ 371 Date: Feb. 3, 2025

Related U.S. Application Data
(60) Provisional application No. 63/394,473, filed on Aug. 2, 2022.

(51) Int. Cl. H04W 36/36; H04W 24/06

(52) U.S. Cl. CPC H04W 36/362; H04W 24/06

(57) ABSTRACT

Procedures, methods, architectures, apparatuses, systems, devices, and computer program products directed to control throughput performance. In an embodiment, a method, implemented in a wireless transmit/receive unit (WTRU), comprises receiving, from a network, a measurement configuration information comprising target cells to be measured and a conditional event configuration information for triggering a CHO command; monitoring the current radio conditions of target and serving cells; performing prediction of the radio conditions of target and serving cells; and in response to current radio conditions of a target cell and/or serving cell fulfilling one or more associated radio condition threshold(s) and in response to the predicted radio conditions of a target and/or serving cell fulfilling one or more associated radio condition, executing the CHO command.

### CROSS-REFERENCE TO RELATED APPLICATIONS

The present application claims the benefit of U.S. Provisional Patent Application No. 63/394,473 filed Aug. 2, 2022, which is incorporated herein by reference.

### TECHNICAL FIELD

The present disclosure is generally directed to the fields of communications, software and encoding, including, for example, to methods, architectures, apparatuses, systems directed to measurement reporting and conditional handover that consider current and predicted signal levels.

### BACKGROUND

Conditional Handover (CHO) may provide handover (HO) robustness by enabling a wireless transmit/receive unit (WTRU) to execute the HO without the need to send measurement reports and wait for the HO command, thereby mitigating problems such as the WTRU getting out of the coverage of the serving cell before the reception of the HO command, or even worse, before sending the measurement report. However, CHO has limitations in that it can be resource intensive, as the CHO targets have to reserve resources until the WTRU performs the CHO or until the CHO gets cancelled by the source.

AI/ML based approaches to mobility handling in new radio (NR) may be considered that use anticipated/predicted signal levels of serving and neighbour cells to perform handovers more proactively. However, decisions based only on current radio conditions or only on anticipated conditions have shortcomings.

Accordingly, there is a need to improve mobility decisions.

### SUMMARY

In an embodiment, a method implemented in a wireless transmit/receive unit may comprise a step of receiving, from a network, a first message comprising predictive measurement configuration information of radio conditions for target and serving cells. The method may further comprise a step of receiving, from the network, a second message comprising handover configuration information, the handover configuration information indicating one or more first triggering conditions, related to current radio conditions, of the target and serving cells and one or more second triggering conditions, related to predicted radio conditions, of the target and serving cells. The method may further comprise a step of determining current radio conditions of a first target cell and a first serving cell fulfilling the one or more first triggering conditions and a step of determining predictive radio conditions of the first target and serving cells, based on the received predictive measurement configuration information, fulfilling the one or more second triggering conditions. The method may comprise a

After the determination of the current radio conditions and the predictive radio conditions respectively fulfilling the one or more first and second triggering conditions, or in response to the determination of the current radio conditions and the predictive radio conditions respectively fulfilling the one or more first and second triggering conditions, the method may further comprise a step of transmitting, to the first target cell, information indicating a handover is executed.

In an embodiment, a method implemented in a wireless transmit/receive unit (WTRU), may comprise a step of receiving, from a network, a measurement configuration information comprising target cells to be measured and a conditional event configuration information for triggering a CHO command. The method may further comprise a step of monitoring the current radio conditions of target and serving cells. The method may further comprise a step of performing prediction of the radio conditions of target cells and serving cells. The method may further comprise a step, wherein in response to current radio conditions of a target cell and/or serving cell fulfilling one or more associated radio condition threshold(s) and in response to the predicted radio conditions of a target and/or serving cell fulfilling one or more associated radio condition threshold(s), of executing the CHO command.

In another embodiment, a method, implemented in a wireless transmit/receive unit (WTRU), may comprise a step of receiving, from a network, a measurement configuration information comprising target cells to be measured and an event configuration information for triggering one or more measurement reports. The method may further comprise a step of monitoring the current radio conditions of target cells and serving cells. The method may further comprise a step of performing prediction of the radio conditions of target cells and serving cells. The method may further comprise a step, wherein in response to current radio conditions of a target cell and/or serving cell fulfilling one or more associated radio condition threshold(s) and in response to the predicted radio conditions of a target and/or serving cell fulfilling one or more associated radio condition threshold(s), transmitting one or more measurement reports to the network.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communication system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a message flow diagram illustrating an example of a handover procedure;

FIG. 3 is a message flow diagram illustrating an example of a conditional handover configuration and execution;

FIG. 4 is a system diagram illustrating Conditional Handover for two WTRU following different trajectory; and

FIG. 5 is a flow chart illustrating an example of a method, implemented in a WTRU, for executing a conditional handover towards a target neighbor cell.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

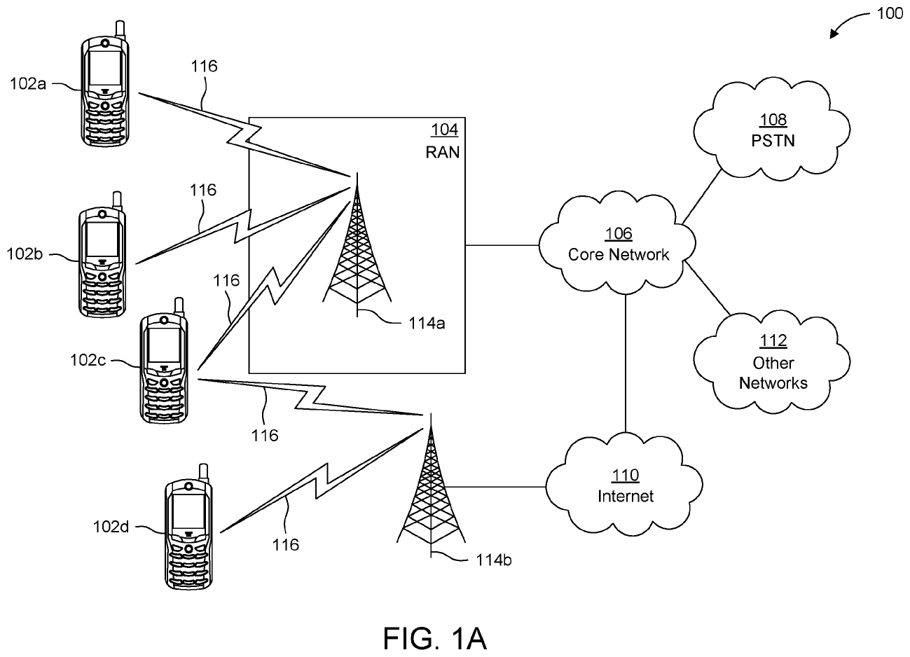

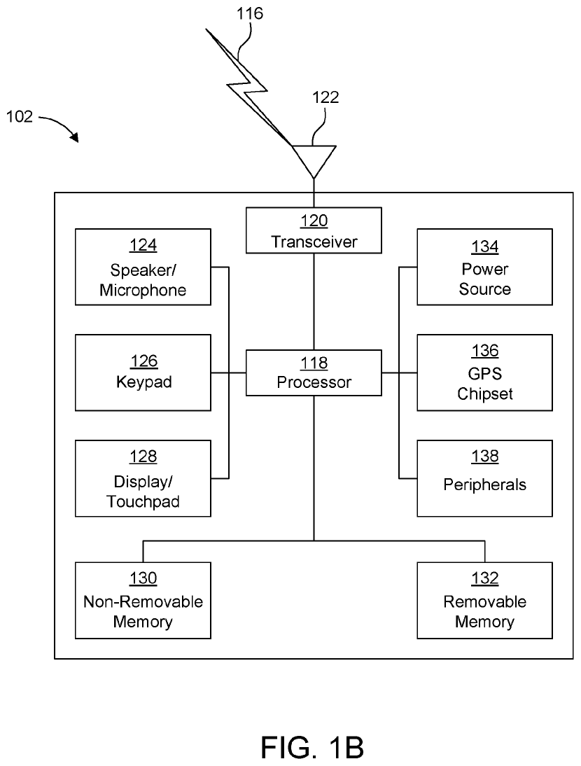

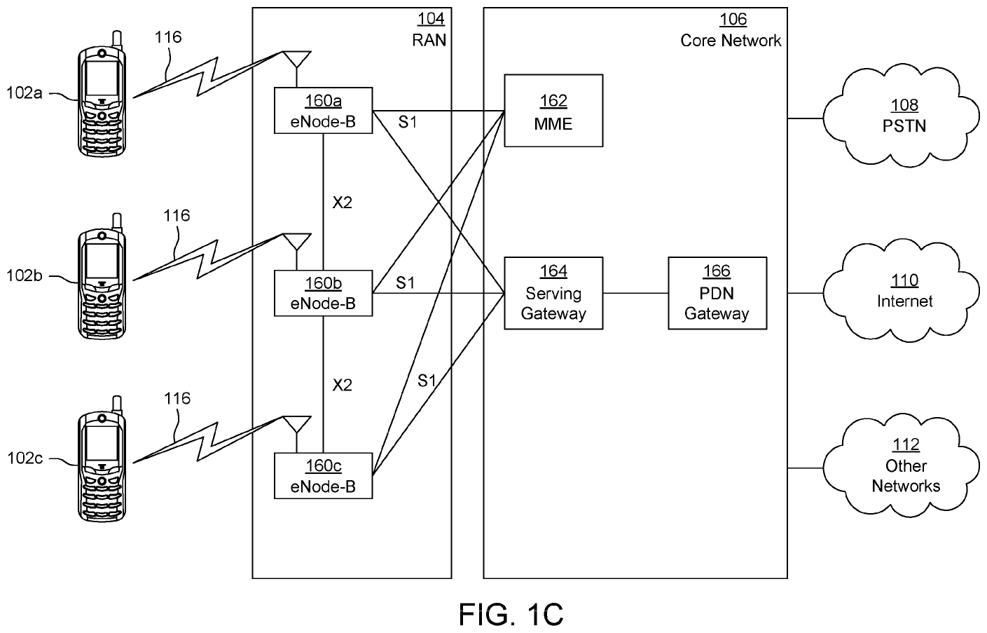

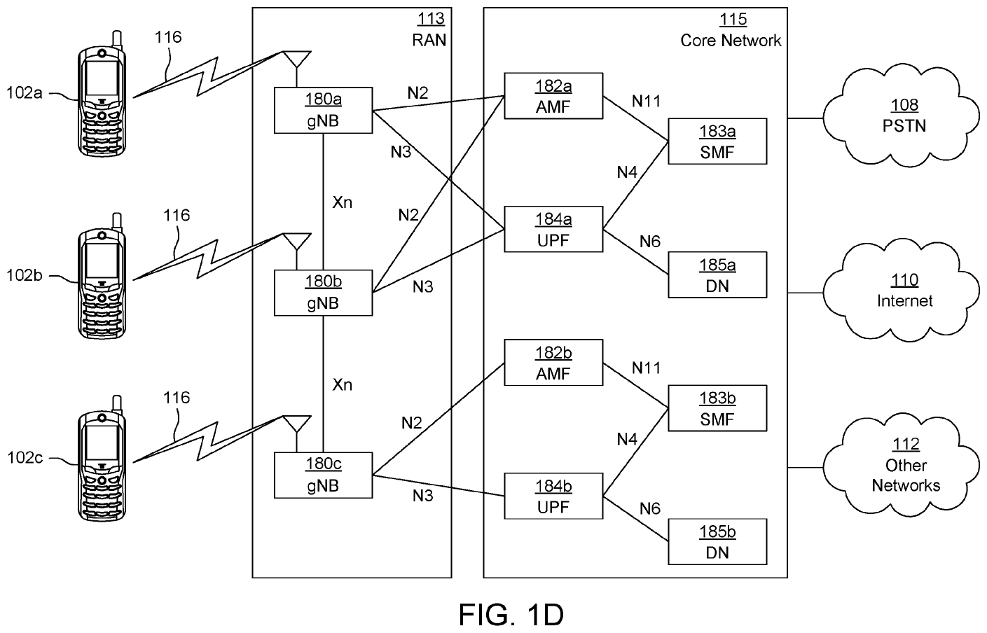

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction on Handover Procedure in NR

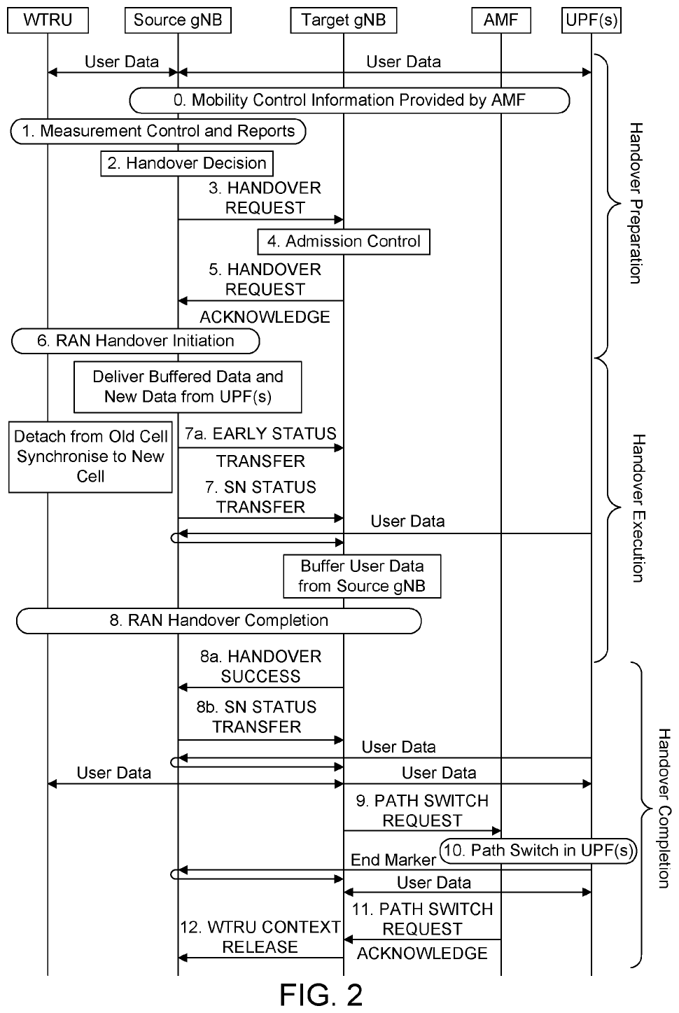

FIG. 2 depicts an example of a basic handover procedure in NR. At step 0, a WTRU context within a source gNB may contain information regarding roaming and access restrictions which were provided either at connection establishment or at the last TA (Timing Advance) update. At step 1, the source gNB may configure the WTRU measurement procedures and the WTRU may report according to the measurement configuration. At step 2, the source gNB may decide to handover the WTRU, based on the received measurements. At step 3, The source gNB may issue a Handover Request message to a target gNB passing a transparent radio resource control (RRC) container with necessary information to prepare the handover at the target side. The information may include at least the target cell identifier (ID), Key gNB, the cell-Radio Network Temporary Identifier (C-RNTI) of the WTRU in the source gNB, radio resources management-configuration (RRM-configuration) including WTRU inactive time, basic access stratum configuration (AS-configuration) including antenna Info and DL Carrier Frequency, the current QoS flow to Data Radio Bearer (DRB) mapping rules applied to the WTRU, the System Information Block Type 1 (SIB1) from source gNB, the WTRU capabilities for different RATs, PDU session related information, and can include the WTRU reported measurement information including beam-related information if available. At step 4, an admission control may be performed by the target gNB. At step 5, if the WTRU can be admitted, the target gNB may prepare the handover with L1/L2 and may send a HANDOVER REQUEST ACKNOWLEDGE to the source gNB, which includes a transparent container to be sent to the WTRU as an RRC message to perform the handover. At step 6, the source gNB may trigger a Uu handover by sending an RRCReconfiguration message to the WTRU, containing the information required to access the target cell: at least the target cell ID, the new C-RNTI, the target gNB security algorithm identifiers for the selected security algorithms. It may also include a set of dedicated random access channel (RACH) resources, the association between RACH resources and synchronization signal blocks (SSB(s)), the association between RACH resources and WTRU-specific channel state information reference signal (CSI-RS) configuration(s), common RACH resources, and system information of the target cell, etc. At step 7, the source gNB may send a sequence number (SN) STATUS TRANSFER message to the target gNB to convey the uplink packet data convergence protocol (PDCP) SN receiver status and the downlink PDCP SN transmitter status of DRBs for which PDCP status preservation applies (e.g., for radio link control acknowledgement mode (RLC AM)). At step 8, The WTRU may synchronize to the target cell and may complete the RRC handover procedure by sending RRCReconfigurationComplete message to target gNB. At step 9, the target gNB may send a PATH SWITCH REQUEST message to access and mobility management function (AMF) to trigger 5GC to switch the DL data path towards the target gNB and to establish an NG-C interface instance towards the target gNB. At step 10, 5GC may switch the DL data path towards the target gNB. A user plane function (UPF) may send one or more “end marker” packets on the old path to the source gNB per PDU session/tunnel and then can release any U-plane/transport network layer (TNL) resources towards the source gNB. At step 11, the AMF may confirm the PATH SWITCH REQUEST message with a PATH SWITCH REQUEST ACKNOWLEDGE message. At step 12, upon reception of the PATH SWITCH REQUEST ACKNOWLEDGE message from the AMF, the target gNB may send a WTRU CONTEXT RELEASE to inform the source gNB about the success of the handover. The source gNB may then release radio and C-plane related resources associated to the WTRU context. Any ongoing data forwarding may continue.

### Example of Conditional Handover (CHO) and Conditional PSCell Change (CPC) in NR

3GPP Release 16 NR introduced the concept of conditional handover (CHO) and conditional PSCell Addition/Change (CPA/CPC, or collectively referred to as CPAC), with the main aim of reducing the likelihood of radio link failures (RLF) and handover failures (HOF).

Legacy LTE/NR handover may be typically triggered by measurement reports, even though there is nothing preventing the network from sending a HO command to the WTRU even without receiving a measurement report. For example, the WTRU may be configured with an A3 event that triggers a measurement report to be sent when the radio signal level/quality (RSRP, RSRQ, . . . ) of a neighbor cell becomes better than the Primary serving cell (PCell) or also the Primary Secondary serving Cell (PSCell), in the case of Dual Connectivity (DC). The WTRU may monitor the serving and neighbor cells and will send a measurement report when the conditions get fulfilled. When such a report is received, the network (current serving node/cell) will prepare a HO command (basically, an RRC Reconfiguration message, with a reconfigurationWithSync) and may send it to the WTRU. The WTRU may execute the HO command (e.g., immediately) resulting in the WTRU connecting to the target cell.

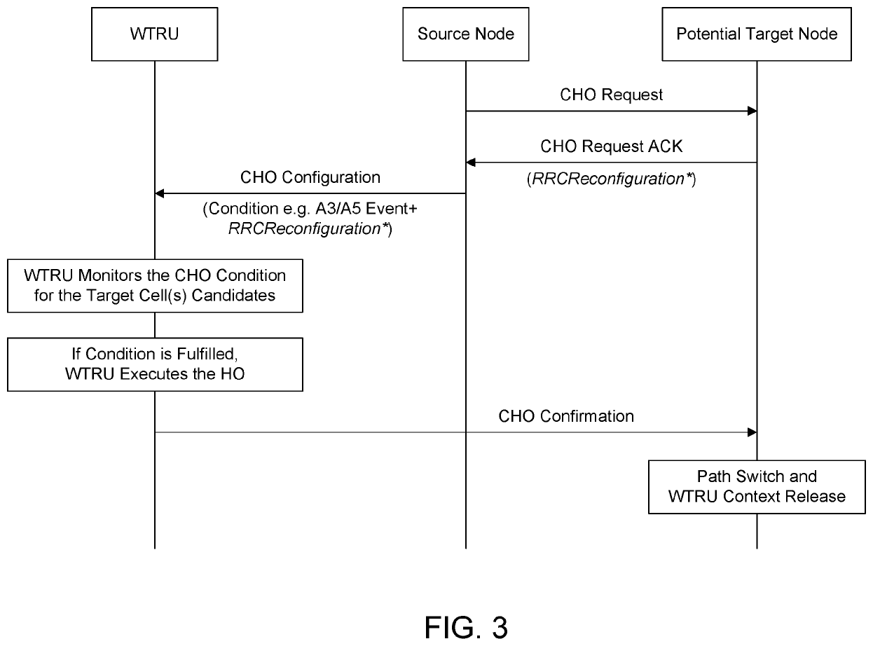

According to FIG. 3, CHO may differ from legacy handover into main aspects:
a) Multiple handover targets (e.g., potential target nodes) may be prepared (as compared to only one target in legacy case)
b) The WTRU may not immediately execute the CHO as in the case of the legacy handover. Instead, the WTRU may be configured with triggering conditions (e.g., A3/A5 event) based on a set of radio conditions, and the WTRU executes the handover towards one of the potential target nodes only when/if the triggering conditions are fulfilled.

Another benefit of CHO is in helping prevent unnecessary re-establishments in case of a radio link failure (RLF). As an example, wherein the WTRU is configured with multiple CHO targets and the WTRU experiences an RLF before the triggering conditions with any of the targets gets fulfilled, legacy operation would have resulted in RRC re-establishment procedure that would have incurred considerable interruption time for the bearers of the WTRU. However, in the case of CHO, if the WTRU, after detecting an RLF, ends up a cell for which it has a CHO associated with (e.g., the target cell is already prepared for it), the WTRU will execute the HO command associated with this target cell directly, instead of continuing with the full re-establishment procedure.

CPC and CPA are just extensions of CHO, but in DC scenarios. A WTRU could be configured with triggering conditions for PSCell change or addition, and when the triggering conditions are fulfilled, it will execute the associated PSCell change or PSCell add commands.

### Measurement and Event Configurations Example for HO and CHO

The measurement configuration provided to the WTRU may contain any of measurement objects, Reporting configurations, Measurement ID configurations, S-measure configuration, Quantity configuration and Measurement gap configuration.

A measurement object may specify what (e.g., exactly) the WTRU has to measure and some information regarding how the measurement is to be performed. This may include information such as the RAT, frequency, sub carrier spacing, SSB periodicity/offset/duration, reference signals and signal types to be measured, list of allowed/excluded neighbor cells of the concerned RAT/frequency to be measured, measurement gaps, offset that can be applied to prioritize/de-prioritize certain cells, etc.

A WTRU may be configured with multiple measurement objects, and a WTRU may have measurement configurations that can be related to different frequencies or even different RAT. A WTRU may be configured with up to 64 measurement objects, and each measurement object is identified by a measurement object ID.

A reporting configuration may specify what is to be reported (e.g., reference signal type such as CSI-RS or SSB, the beam and cell level quantities to be reported such as RSRP/RSRQ, maximum number of cells or/and beams to be reported, etc.,) and the reporting criteria, upon the fulfilment of which the WTRU either sends a measurement report or executes an associated HO configuration in the case of CHO. The reporting criteria may be just the expiry of a periodic timer (periodic reporting configuration) or based on some radio conditions of serving and/or neighbor cells. A WTRU may be configured with up to 64 reporting configurations, and each reporting configuration may be identified by a reporting configuration ID.

A measurement object may be associated with one or more reporting configurations. This association may be made through a measurement ID. Basically, the measurement ID configuration may a list of any of a measurement ID, a measurement object ID and a reporting configuration ID. A WTRU may be configured with up to 64 measurement IDs.

There are several ways of configuring event triggered reporting, the main ones being any of:
Event A1 (Serving cell becomes better than threshold)
Event A2 (Serving becomes worse than threshold)
Event A3 (Neighbour becomes offset better than SpCell)
Event A4 (Neighbour becomes better than threshold)
Event A5 (SpCell becomes worse than threshold1 and neighbour becomes better than threshold2)
Event A6 (Neighbour becomes offset better than SCell)
Event B1 (Inter RAT neighbour becomes better than threshold)
Event B2 (PCell becomes worse than threshold1 and inter RAT neighbour becomes better than threshold2)

The term SpCell refers to a PCell (Primary Cell), or in the case of DC, the Primary Secondary Cell (PSCell). Event A3, A5, B2 can only be configured for the PCell or PSCell.

Events A1, A2, A3, A5, B2 may be configured for any serving cell. Event A6 may be configured only for SCells (i.e., for the secondary cells in carrier aggregation, CA). Events A4 and B1 are only related to neighbour cell measurements (and thus not related to any serving cell)

Each event configuration may be associated with a threshold (offset), hysteresis and TimeToTrigger (TTT) parameters, as exemplified in the configurations for some of the A events shown below (taken from 3GPP TS 38.331 version 16.3.1 Release 16: ReportConfigNR information element):

| eventA1 | SEQUENCE { |
|---|---|
| a1-Threshold | MeasTriggerQuantity, |
| reportOnLeave | BOOLEAN, |
| hysteresis | Hysteresis, |
| timeToTrigger | TimeToTrigger |
| }, | |
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |
| }, | |
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |
| }, | |
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |
| }, | |
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |
| }, | |
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

In the case of CHO, instead of sending a measurement report when the reporting conditions are fulfilled, the WTRU may execute a HO command. For CHO, any of the following event triggered reporting configurations are defined: CondEvent A3 (Neighbour becomes offset better than SpCell), CondEvent A4 (Neighbour becomes better than threshold) and CondEvent A5 (SpCell becomes worse than threshold1 and neighbour becomes better than threshold2)

A CHO configuration may contain any of conditional reconfiguration ID, conditional reconfiguration triggering condition and RRC reconfiguration to be executed when the conditions are fulfilled (e.g., HO command)

The triggering conditions may be a reference to one or two measurement IDs (measID), and two measurement IDs are specified, then these two measurement IDs may refer to the same measurement object (e.g., one measID associating the measurement object related to the PCell with an A3 event and another measID associating the same measurement object with an A5 event)

According to 3GPP release 17, the WTRU may be configured with a maximum of eight CHO configurations.

### Example of Predicted Measurement Reporting and CHO Based on Predicted Measurements

Both regular HO and CHO are reactive mechanisms, in a sense that the decision may be based on current radio conditions of serving and/or neighboring cells. With the advancement of artificial intelligence/Machine learning (AI/ML) mechanisms, it may be anticipated that models may be trained that can predict the signal levels of serving and/or neighboring cells accurately, at least within a short/limited time horizon.

For example, a WTRU may be configured to send predictive measurement reports (e.g., report sent when signal levels of serving and/or neighboring cells at a given time in the future fulfill an absolute or relative threshold, or even a time series of such predicted measurements) and based on that, the network may be able to make optimal decisions. For example, based on such predicted measurements, the network is enabled to configure the CHO proactively at the right time, thereby reducing the amount of time resources need to be reserved at the targets. Predictive CHO could also be defined where the WTRU executes the associated CHO command when the CHO conditions are expected to be fulfilled within a certain time in the future.

In 3GPP Release18, there are several study/work items (e.g., RAN3: RP-220635, RAN1: RP-221348.zip) looking into AI/ML mechanisms. AI/ML based approaches to mobility handling in NR may be being considered that use anticipated/predicted signal levels of serving and neighbour cells to perform handovers more proactively.

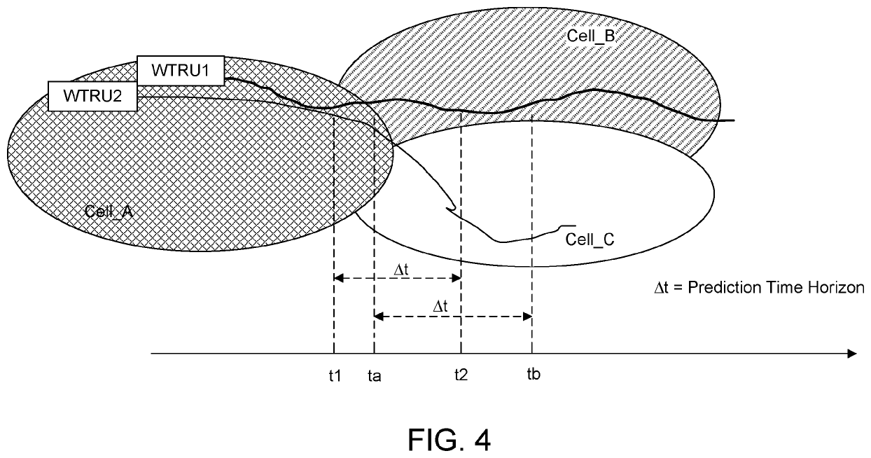

Referring to FIG. 4, two WTRUs (WTRU1 and WTRU2) follow different trajectories across three cells (Cell_A, Cell_B and Cell_C). In case both WTRUs are configured with CHO configurations (e.g., to be triggered when a neighbour cell becomes better than the serving cell by more than a certain threshold), and at time t1, the conditions for triggering a CHO towards cell B are fulfilled for both WTRUs, and as such, both WTRUs are handed over towards cell B.

However, soon after the CHO, the two WTRUs may follow different trajectory as depicted in the FIG. 4. While WTRU1 remains within the coverage of cell_B for a considerable time, WTRU2 quickly goes out of coverage, thereby triggering a HO (or CHO) towards cell_C, assuming the network has properly configured measurements and/CHO configurations regarding that, or even worse, a re-establishment due to RLF.

If predictive CHO was configured (and assume the prediction time horizon is Δt), then at t1, the conditions for predictive CHO towards cell_B were fulfilled for WTRU1, and the CHO towards cell_C were fulfilled for WTRU2. However, the current radio conditions of cell C for WTRU2 may be not good enough at time t1, and as such it may be not desirable to execute the CHO yet.

Therefore, mobility decisions based only on current radio conditions or only on anticipated conditions have shortcomings.

Example of Using Current and Anticipated Radio Conditions of Serving and/or Neighbor Cells to Enable Optimal Mobility Decision

In the descriptions below the term AI/ML (Artificial Intelligence/Machine Learning) is used to describe any model and associated learning algorithm used by the WTRU or/and network to predict future behavior. The model and associated learning algorithm are assumed to utilize a big set of data collected by the WTRUs and/or network. The details about the model and the associated learning algorithm are outside the scope of this disclosure, and the focus here is rather on the effective communication between the WTRU and the network to enable optimal mobility decisions that could benefit both the WTRU and the network.

In the descriptions below the terms “future”, “expected”, “anticipated”, “estimated”, “predictive” and “predicted” (and their adverb variants) are used interchangeably.

In the descriptions below, the term “time horizon” is used to refer to the time duration (e.g., delta time between the current time and a future time) wherein the WTRU is able to make accurate prediction of serving/neighbor cells reach the predicted signal levels.

In the descriptions below, the term “measurement prediction” is used to refer to prediction of signal levels of serving/neighbor cells.

In the descriptions below, the terms “execute a CHO”, “execute a reconfiguration associated with a CHO configuration”, “execute a HO associated with a CHO configuration” are used interchangeably.

In the descriptions below, the term “measurement event” refers to a reporting configuration associated with certain measurement object, whereupon the fulfillment of the triggering conditions for the event, a measurement report is sent.

In the descriptions below, the term “conditional event” refers to a reporting configuration associated with a CHO configuration, whereupon the fulfillment of the triggering conditions for the event, a CHO is executed.

In the descriptions below “measurements”, unless otherwise specified, refer to serving cell and neighbor cell measurements, at least containing measurement result for the serving cell and/or neighbor cell that is associated with the concerned event.

In most of the descriptions of the embodiments below, we have focused on Ax events for the sake of brevity. However, all the embodiments are equally applicable for Bx events (e.g., for inter-RAT measurement reporting or inter-RAT CHO).

In the descriptions below of the embodiments regarding the measurement reporting or CHO that consider current and predicted measurement, the main focus has been put on describing the triggering conditions. In 3GPP specifications, the embodiments may be realized in different ways. For example:
a PredEventAx/Bx may be defined that has measurement report triggering conditions for predicted measurements and this may be associated with another legacy Ax/Bx event that has triggering conditions for current measurements (e.g., WTRU receiving a mapping/association between the two events). The two events may or may not be associated with the same measurement object.
a PredEventAx/Bx may be defined that has measurement report triggering conditions for predicted measurements as well as current measurements.
a PredCondEventAx/Bx may be defined that has CHO triggering conditions based on predicted measurements and this may be associated with a legacy CondEventAx/Bx that has CHO triggering conditions based on current measurements (e.g., WTRU receiving a mapping/association between the two events). The two events may or may not be associated with the same measurement object. The CHO command can be associated to one of the events (e.g., PredCondEventAx or CondEventAx) or both.
a PredCondEventAx/Bx may be defined for CHO that has triggering conditions for predicted measurements as well as current measurements.
A combination of the above can also be envisioned, for example, event Ax/Bx associated with the current measurements, and PredCondEventAx/Bx associated with future measurements, where the CHO associated with the later.

### WTRU Indicating to the Network Measurement Prediction Capability

In an embodiment, the WTRU may indicate to the network its capability to perform signal level prediction of serving and/or neighbor cells.

In an embodiment, the WTRU may indicate to the network its capability according to legacy WTRU capability transfer (e.g., network sending a WTRUCapabilityEnquiry and WTRU responding with WTRUCapabilityInformation). A capability filtering information that is related to WTRU's UL data prediction may be introduced in the WTRUCapabilityEnquiry message.

The capability information may be as simple as a binary “yes/no” or it may be a detailed one containing any of the following:
Prediction time horizon (e.g., WTRU may predict the signal levels of serving/neighbor cells for up to x millisecond (ms) in advance)
   In various embodiments, the WTRU may indicate the capability in terms of prediction time window length, for example, i.e., signal level to be within a certain range as early as X ms and as late as Y ms).
   In various embodiments, the WTRU may have different time horizons for serving cells and neighbor cells
   In various embodiments, the WTRU may have different time horizons for different frequencies.
   In various embodiments, the WTRU may have different time horizons for different RATs.
   In various embodiments, the WTRU may have different time horizons for different times of the day (e.g., longer time horizons between certain times, say 12 am and 4 am, where the UE is likely to be stationery and interference to be limited as compared to times, say 7 am to 9 am, where the WTRU is expected to be mobile, and interference to be high)·
Confidence level of the prediction (e.g., WTRU's confidence on the prediction is 95%)
   Confidence level may also be expressed in terms of margin of error (e.g., RSRP prediction is +/−xdbm, RSRQ prediction is +/−ydb, etc.)
Time duration(s) where the prediction may be applicable (e.g., WTRU may be able to do an accurate prediction only during 8 pm and 1 am)
Location(s) where the predictions may be applicable (e.g., range of GNSS/GPS co-ordinates, set of cell IDs, etc.)
Granularity of prediction, which may contain one or more of the following:
   the delta (plus or minus) to be applied to determine the range of expected data (e.g., a delta of d signifies that the network should consider the expected signal level to be between r−d and r+d, where r is the reported expected measurement from the WTRU). It should be noted that the WTRU may instead always report a range of values without the need to communicate the delta, but that will lead to higher resource utilization for the measurement reporting.
The specific measurement quantity that the WTRU may predict. For example, the WTRU may indicate support for prediction of one or more or a combination of the following measurement quantities, RSRP, RSRQ, SINR etc.
Maximum number of cells for which the WTRU may support prediction. Possibly expressed as maximum number of cells across all frequencies for which the WTRU may support predictions. Possibly the WTRU may indicate this capability specific to different granularity or time horizon prediction. For example, a first value for max number of predicted cells given a first set of granularity/time horizon for prediction and a second value for max number of predicted cells given a second set of granularity/time horizon for prediction.
Maximum number of intra-frequencies/inter-frequencies for which the WTRU may support prediction. Additionally, the WTRU may indicate maximum number of cells per frequency for which the WTRU may supports prediction. For example, this capability may also be conditioned upon number of granularity/time horizon of prediction.

In an embodiment, the WTRU may indicate to the network a multitude of signal level prediction capabilities. For example:
capability 1: prediction for up to x1 ms in advance, confidence level c1 (or error range of e1), time duration t1, location l1, . . .
capability 2: prediction for up to x2 ms in advance, confidence level c2 (or error range of e2), time duration t2, location l2, . . .
etc. . . . .

In an embodiment, the WTRU may indicate to the network if it able to perform the prediction according to only one prediction capability at a given time or it can perform multiple predictions at once. For example, WTRU may indicate that it is capable of performing the measurement prediction at a given time according to at least:
only one of the indicated capabilities;
a subset of the indicated capabilities (e.g., capability 1 and 2, capability 1 and 3, capability 2, 4, and 5, etc.);
all the indicated capabilities as long as some capabilities are not employed together (e.g., capabilities 1 and 3 cannot be used at the same time);
all the indicated capabilities;
etc. . . . .

In an embodiment, if the WTRU is not capable of performing the prediction according to all its capabilities at once, the WTRU may indicate to the network the preference level of the different capabilities or sets of capabilities that can be employed together.

### Network Choosing the WTRU Measurement Prediction Capability to be Employed

In an embodiment, the network may indicate to the WTRU the measurement prediction capability (or capabilities) to be employed. For example, once the network has received an indication that the WTRU may support a certain number of measurement prediction capabilities, it may configure the WTRU to operate the measurement prediction according to one of the indicated capabilities.

In an embodiment, the network may indicate to the WTRU to perform the measurement prediction according to more than one UL prediction capability (e.g., simultaneously).

In an embodiment, the network may indicate to the WTRU to perform the measurement prediction according to more than one prediction capability, but it may leave the final decision which of the capabilities the WTRU may choose. The WTRU may indicate the chosen capability(ies) in a response message. For example, the network may indicate to the WTRU that it may have to predict the measurements according to capability 1 or 2. WTRU choosing capability 1, may send a message to the network indicating the chosen prediction capability.

In an embodiment, the network may indicate to the WTRU to perform UL measurement prediction according to more than one prediction capability, and it may include further constraints regarding when the WTRU should perform the prediction according to the indicated capabilities. For example, the network may indicate to the WTRU to have capability 1 to be used during a certain time period (e.g., between 8 am and 8:30 am) or/and a certain location (e.g., range of GNSS locations, cell identities, while being served by certain RATs or/and frequencies, etc.,). Instead of or in addition to absolute time/location constraints, the network may indicate relative constraints (e.g., delta time/location from the current time/location).

In an embodiment, a combination of the above two embodiments may be configured (e.g., network may put a constraint regarding when/where the predictions is to be performed/reported, such as time or location, and which prediction capability is to be employed is left for the WTRU to decide).

In an embodiment, the configuration of the capability (or capabilities) to be employed for measurement prediction may be indicated to the WTRU using an RRC message.

In an embodiment, the configuration of the capability (or capabilities) to be employed for measurement prediction is indicated to the WTRU using an MAC CE.

In an embodiment, the configuration of the capability (or capabilities) to be employed for measurement prediction may be indicated to the WTRU using a downlink control information (DCI).

In an embodiment, the configuration of the capability(ies) to be employed for measurement prediction may be indicated to the WTRU using broadcast signaling (e.g., SIB).

### Network Sending Measurement Prediction Model to the WTRU

In an embodiment, the network may configure the WTRU with an AI/ML model that is to be used for measurement prediction.

In an embodiment, in addition to the measurement prediction model, the network may configure the WTRU with conditions when to send measurement reports based on the inference from this model. Conditions example may be any of the following conditions:
Immediately, e.g., as long as the trigger conditions are fulfilled;
after the WTRU has done the training of the model for a certain specified duration;
after the WTRU has compared the predicted measurements with the actual values (e.g., saving the predicted measurements and comparing them with the actual measurements after the time horizon duration has elapsed), and have determined that the accuracy/confidence level is above a configured threshold (or error level is below a certain range),
after the WTRU has done some training rounds of the model until the error or confidence associated with the first future output of the model is above a certain threshold, considering only the estimate error or confidence of the prediction
after the WTRU has done some training rounds of the model until the error or confidence associated with a certain number of first future outputs of the model are above a certain threshold, considering only the estimate error or confidence of the predictions
etc.

In an embodiment, the WTRU may be configured with AI/ML model for measurement prediction, wherein the specific inputs to AI/ML models are preconfigured. For example, the WTRU may be configured to input historical measurements, time of the day, current location, etc.,

### Activation/Deactivation of Measurement Prediction

In an embodiment, the choice of the capability (or capabilities) to be used for the measurement prediction by the network may be considered by the WTRU to be an indication to start the measurement prediction/reporting according to the chosen/indicated capability (or capabilities). If a constraint (e.g., time, location, etc.) was configured for the prediction according to any of the solutions above, the WTRU may perform the prediction/reporting only when those constraints/conditions are fulfilled.

In an embodiment, the WTRU may wait for the reception of an additional explicit activation message/indication for the start of predictive measurement reporting. If more than one capability was chosen/configured, the capability(ies) to be employed for the measurement prediction/reporting may be included in the activation message/indication. If more than one capability was chosen/configured, the network may indicate to the WTRU with an explicit flag to employ all capabilities at once, instead of separately including all the chosen capabilities.

In an embodiment, the WTRU may receive a deactivation message/indication to stop performing/reporting the measurement prediction. If more than one capability was activated, the capability or capabilities to be deactivated for the measurement prediction/reporting can be included in the deactivation message/indication. If more than one capability was activated and the network wants to stop all measurement prediction/reporting, it may indicate that using an explicit flag instead of separately including all the prediction capabilities to be deactivated.

In an embodiment, the WTRU may perform the activation/deactivation of the measurement prediction/reporting upon the reception of such a message.

In an embodiment, additional information may be included in the activation/deactivation message indicating when the activation/deactivation should take effect. For example, a delta time may be included in the deactivation message, and the WTRU may wait until the indicated delta time has elapsed after the reception of the deactivation message before deactivating the measurement prediction/reporting (either according to the indicated capability or all measurement prediction/reporting, if that was indicated).

In an embodiment, the activation/deactivation signaling may be performed via RRC.

In an embodiment, a MAC CE may be used for the activation/deactivation signaling.

In an embodiment, a DCI may be used for the activation/deactivation signaling.

In an embodiment, the activation/deactivation may be indicated using broadcast signaling.

### Joint Measurement Reporting Condition Based on Current and Predicted Signal Levels

In an embodiment, the WTRU may be configured to send a measurement report when certain conditions (e.g., thresholds) are fulfilled (e.g., currently), and certain conditions (e.g., thresholds) are predicted to be fulfilled at a future time (e.g., measurement prediction time horizon, a time earlier than that, etc.).

In an embodiment, the same measurement event, as well as same trigger thresholds, are used for the current and future measurements. For example, the WTRU may be configured with an A3 event configuration (neighbor cell better than the PCell/PSCell by a certain threshold, thresh1), and will send a measurement report when the conditions get fulfilled and the same conditions are expected to be fulfilled also at a future time, wherein the future time may be current time plus prediction time horizon.

In an embodiment, the same measurement event may be used for the current and future measurements, but different trigger thresholds are used for the current and future measurements. For example, the WTRU may be configured with an A3 event configuration and a first threshold (thresh1) associated with current measurements and a second threshold (thresh2) associated with future measurements. The WTRU may send a measurement report when the current measurements fulfill thresh1 and future measurements are expected to fulfill thresh2, wherein the future time may be current time plus prediction time horizon.

In an embodiment, the same measurement event may be used for the current and future measurements, but different timeToTrigger (TTT) values may be used for current and future measurements. For example, the WTRU may be configured with an A3 event configuration and thresh1 associated with both current and future measurements, but with a first time to trigger value (TTT1) for current measurements and a second time to trigger value (TT2) for future measurements. The WTRU will send a measurement report when the current measurements fulfill thresh1 for TT1 and future measurements are expected to fulfill thresh1 for TT2, wherein the future time may be current time plus prediction time horizon.

In an embodiment, the same measurement event may be used for the current and future measurements, but different hysteresis values are used for current and future measurements. For example, the WTRU may be configured with an A3 event configuration and thresh1 associated with both current and future measurements, TTT associated with both current and future measurements, but with hysteresis value of h1 for current measurements and h2 for future measurements.

In an embodiment, the WTRU may be configured with existing measurement events and may use measurement prediction instead of time to trigger mechanism. For example, upon meeting entry condition associated with the measurement event, the WTRU may perform measurement prediction to predict the measurement result at a time offset corresponding to TTT instead of waiting for TTT to expire.

In various embodiments, the same measurement event may be used for the current and future measurements, but all or a subset of the event parameters may be different for the current and future measurements. For example, thresholds and TTT being different, thresholds and hysteresis being different, all parameters being different (e.g., different TTT, hysteresis, threshold, etc.,)

In an embodiment, different measurement events may be used for the current and future measurements. For example, the WTRU may be configured with an A3 event configuration for the current measurements and configured with event A4 (neighbor cell becomes better than a certain threshold). The WTRU will send a measurement report when the current measurements of a certain neighbor cell fulfill the A3 conditions currently and the measurements of the same neighbor cell are expected to fulfill the A4 conditions at a future time (e.g., at current time plus prediction time horizon).

WTRU Actions when the Joint or One of the Current/Future Measurement Reporting Conditions are Fulfilled

In an embodiment, when the current and future conditions are fulfilled, according to any of the solutions above, the WTRU may send a measurement report that contains measurement results that contain the current measurement results and/or the predicted measurement results. The predicted part of the measurement result may contain further information such as prediction confidence level, margin/range of error, time horizon information, etc. (e.g., if that information is not implicitly clear from initial configuration of predictive measurement reporting).

In an embodiment, when the current and future conditions are fulfilled, according to any of the embodiments above, the WTRU may send (e.g., just) an indication to the network to inform it that the conditions are fulfilled, without including detailed measurement reports at all.

In an embodiment, when the current conditions are fulfilled, but the future conditions are expected not to be fulfilled, the WTRU may send an indication to the network. This indication could be a simple indication informing the network about the situation, or it may contain detailed current and/or predicted measurements.

In an embodiment, when the current conditions are not fulfilled, but the future conditions are expected to be fulfilled, the WTRU may send an indication to the network. This indication could be a simple indication informing the network about the situation, or it may contain detailed current and/or predicted measurements.

In an embodiment, based on any of the embodiments above where the WTRU (e.g., just) sends an indication to the network regarding the fulfillment of the joint condition or the fulfillment of just one of the current/future conditions, the network may (e.g., subsequently) send a request to the WTRU to send the measurement results. The request may indicate what is to be included in the report (e.g., current measurements, predicted measurements, both). Up on the reception of such a request, the WTRU may provide the measurements.

In an embodiment, when the current and/or future conditions are fulfilled, according to any of the embodiments above, the WTRU may decide to send (e.g., just) an indication or a detailed measurement report including current and/or future anticipated measurements based on any of the following factors:
how much UL grant it has available (e.g., send the indication only if there is no UL grant big enough to send the detailed measurements, send indication and current measurements if UL grant is big enough to accommodate both, send the detailed current and future anticipated measurement if there is enough UL grant)
the current signal level towards the concerned serving cell (e.g., send only the indication if the current serving cell's signal level is below a certain threshold, to ensure the fast reception of the indication by the network and thus facilitate the faster reception of a HO/reconfiguration before the serving cell's signal becomes too low)

### CHO Based on Current and Predicted Signal Levels

In one embodiment, the WTRU may be configured to execute a CHO when certain conditions (e.g., thresholds) are fulfilled currently, and certain conditions (e.g., thresholds) are fulfilled at a future time (e.g., measurement prediction time horizon, a timer earlier than that, etc.).

In one embodiment, the same conditional measurement event, as well as same trigger thresholds, may be used for the current and future conditional events. For example, the WTRU may be configured with a CondEvent A3 (neighbor cell better than the PCell/PSCell by a certain threshold, thresh1), and will execute the CHO when the conditions get fulfilled currently and the same conditions are expected to be fulfilled also at a future time, wherein the future time may be current time plus prediction time horizon.

In an embodiment, the same conditional event may be associated with the current and future measurements, but different trigger thresholds may be used for the current and future measurements. For example, the WTRU may be configured with an CondEvent A3 and thresh1 associated with current measurements and thresh2 associated with future measurements. The WTRU may execute the CHO when the current measurements fulfill thresh1 and future measurements are expected to fulfill thresh2 (where the future time, e.g., is current time+prediction time horizon)

In an embodiment, the same conditional event may be used for the current and future measurements, but different timeToTrigger (TTT) values may be used for current and future measurements. For example, the WTRU may be configured with a CondEvent A3 and thresh1 associated with both current and future measurements, but with TTT1 for current measurements and TT2 for future measurements. The WTRU may execute the CHO when the current measurements fulfill thresh1 for TT1 and future measurements are expected to fulfill thresh1 for TT2 (where the future time, e.g., is current time+prediction time horizon).

In an embodiment, the same conditional event may be used for the current and future measurements, but different hysteresis values are used for current and future measurements. For example, the WTRU may be configured with a CondEvent A3 and thresh1 associated with both current and future measurements, TTT associated with both current and future measurements, but with hysteresis value of h1 for current measurements and h2 for future measurements.

Various embodiments may be envisioned where the same conditional event is used for the current and future measurements, but all or a subset of the event parameters are different for the current and future measurements. For example, thresholds and TTT being different, thresholds and hysteresis being different, all parameters being different (e.g., different TTT, hysteresis, threshold, etc. . . . ).

In an embodiment, different conditional events may be used for the current and future measurements. For example, the WTRU may be configured with CondEvent A3 event configuration for the current measurements and configured with CondEvent A4 (neighbor cell becomes better than a certain threshold). The WTRU may execute the CHO when the current measurements of a certain neighbor cell fulfill the CondEvent A3 conditions currently and the measurements of the same neighbor cell are expected to fulfill the CondEvent A4 conditions at a future time (e.g., current time plus prediction time horizon).

WTRU Actions when Only One of the Current/Future CHO Conditions are Fulfilled

In an embodiment, when the current conditions for a CHO are fulfilled, but the future conditions are expected not to be fulfilled, the WTRU may send an indication to the network. The indication could be a simple indication informing the network about the situation, or it may contain detailed current and/or predicted measurements.

In an embodiment, when the current conditions for CHO are not fulfilled, but the future conditions are expected to be fulfilled, the WTRU may send an indication to the network. The indication could be a simple indication informing the network about the situation, or it may contain detailed current and/or predicted measurements.

In an embodiment, based on any of the embodiments above where the WTRU may (e.g., just) send an indication to the network regarding the fulfillment of just one of the current/future CHO conditions, the network may subsequently send a request to the WTRU to send the measurement results. The request may indicate what is to be included in the report (e.g., current measurements, predicted measurements, both). Up on the reception of such a request, the WTRU may provide the measurements.

In an embodiment, according to any of the embodiments above regarding the WTRU behavior when one of the current or future CHO conditions are not fulfilled, the WTRU may decide to send (e.g., just) an indication or a detailed measurement report including current and/or future anticipated measurements based on any of the following several factors:
how much UL grant it has available (e.g., send the indication only if there is no UL grant big enough to send the detailed measurements, send indication and current measurements if UL grant is big enough to accommodate both, send the detailed current and future anticipated measurement if there is enough UL grant)
the current signal level towards the concerned serving cell (e.g., send only the indication if UL grant if the current serving cell's signal level is below a certain threshold, to ensure the fast reception of the indication by the network and thus facilitate the faster reception of a CHO reconfiguration or HO command before the serving cell's signal becomes too low)

### Others WTRU Mobility Actions

In an embodiment, multiple sets of parameters may be configured for current and future measurement events or conditional events, where there is an association between the two sets of parameters. As a simple example, assume Event A3 or CondEvent A3 may be used and the current measurements may be associated with thresh_x1 and thresh_x2, and the future measurements may be associated with thresh_y1 and thresh_y2. The join conditions on both the current and future measurements may be considered to be fulfilled for the measurement event or conditional event if the current measurements fulfill thresh x1 and future measurements fulfill thresh y1 or if the current measurements fulfill thresh_x2 and future measurements fulfill thresh y2. Different TTT and hysteresis values may also be part of the different set of parameters to be considered.

In an embodiment, if the WTRU was configured with multiple sets of configurations as in the embodiment above, when the conditions are fulfilled, the WTRU may indicate to the network which sets of parameter sets were used for the current and future measurements. For example, each set of parameters may have an identity, and WTRU may include the identity of the parameter set associated with the current measurements and the identity of the parameter set associated with the future measurements that were fulfilled (e.g., in a measurement report sent, in a CHO complete message, etc. . . . ).

In an embodiment, the WTRU may be configured to relax the triggering conditions on the future measurements if the triggering conditions on current measurements are fulfilled. For example, assume that both the current and future measurements are associated with Event A3 or CondEvent A3 and the same values for threshold, TTT and hysteresis. If the conditions for the current measurements are fulfilled, the WTRU may be configured to scale down the threshold value for the future conditions (e.g., by a certain configurable factor, e.g., 80% of the value) and thus can consider the join condition to be fulfilled even though the concerned neighbor cell is not expected to be better than the serving cell by only 0.8*thresh1 in a future time (e.g., current time plus time horizon). Similar modification/scaling of the TTT or hysteresis could also be applied.

In an embodiment, the WTRU may be configured to relax the triggering conditions on the current measurements if the triggering conditions on future measurements are fulfilled. For example, assume that both the current and future measurements are associated with Event A3 or CondEvent A3 and the same values for threshold, TTT and hysteresis. If the conditions for the future measurements are expected to be fulfilled, the WTRU may be configured to scale down the threshold value for the current conditions (e.g., by a certain configurable factor, e.g., 80% of the value) and thus can consider the join condition to be fulfilled even though the concerned neighbor cell is better than the serving cell by only 0.8*thresh1. Similar modification/scaling of the TTT or hysteresis could also be applied.

In an embodiment, if the WTRU has applied relaxation of the current or future triggering conditions, and based on that that joint conditions are fulfilled, the WTRU may send an indication to the network. For example, this indication may be included in the measurement report being sent or in the CHO complete message.

In an embodiment, if the CHO conditions are fulfilled for future measurements but not for the current measurements, but the radio conditions toward the concerned target are reasonably good (e.g., above a certain configured threshold), the WTRU may be configured to execute the CHO.

In an embodiment, the CHO condition may be currently fulfilled for many targets and a subset of the target in the future. In that case, the WTRU may select the target towards which to execute the associated CHO with based on one any of the following:
randomly select one of the targets
select the target that is expected to have the best conditions in the future
select the target that has the best conditions now
select the target that has the best average condition (e.g., average of the current and future signal levels)
select the target(s) based on operating frequency (e.g., prioritize FR1 vs FR2 or vice versa)

In an embodiment, the WTRU may be configured to compare conditions at several time points between the current time and a certain time horizon. For example, the WTRU may be able to predict measurements every x ms, for up to time horizon (e.g., t_1, t_2, . . . , t_final), which refer to predicted samples. The WTRU may be configured to have one triggering threshold that is applicable for all predicted samples or a separate threshold for each sample. The WTRU may compare each predicted measurement sample with the threshold associated with it, and may consider the CHO conditions fulfilled based on any of the following (which behavior(s) to apply may be configured by the network or left to WTRU implementation):
if the conditions are met at all the predicted samples;
if the conditions are met for at least x number of the predicted samples;
if the conditions are met for at least y % of the predicted samples;
if the average of all the signal levels of all the predicted samples meets the average of the thresholds (or the threshold, if only one threshold is associated with all samples);
If the error (e.g., mean square error) of the all the predicted samples falls below a certain configured level, etc. . . . .

In an embodiment, the WTRU may be configured to send the current and/or future measurement results in a CHO complete message.

In an embodiment, if the CHO conditions for both current and future measurements are fulfilled, the WTRU may keep information about the CHO (e.g., for a future report of successful CHO/HO, e.g., to be sent on request from the network)

In an embodiment, if the CHO conditions for the current measurement were fulfilled but not for the future measurements, the WTRU may keep information about this CHO (e.g., for a future report of too late CHO/HO, e.g., to be sent on request from the network)

In an embodiment, if the CHO conditions for the future measurement were fulfilled but not for the current measurements, the WTRU may keep information about the CHO (e.g., for a future report of too early CHO/HO, e.g., to be sent on request from the network).

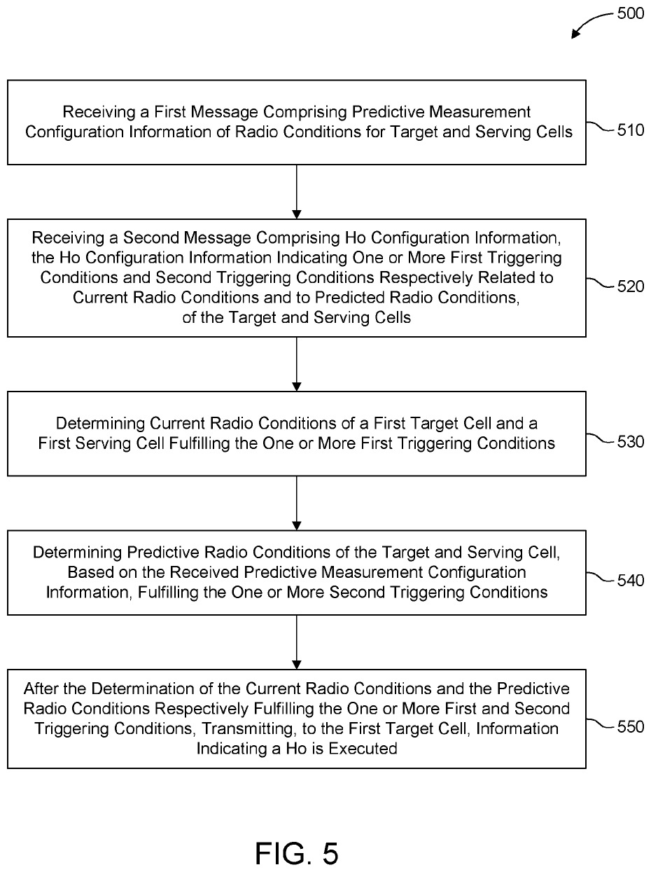

Referring to FIG. 5, a method 500, implemented in a WTRU, for executing a conditional handover towards a target neighbor cell may comprise a step of receiving 510, from a network, a first message comprising predictive measurement configuration information of radio conditions for target and serving cells. The method 500 may comprise another step of receiving 520, from the network, a second message comprising handover configuration information, the handover configuration information indicating one or more first triggering conditions, related to current radio conditions, of the target and serving cells and one or more second triggering conditions, related to predicted radio conditions, of the target and serving cells.

The first triggering conditions and the second triggering conditions may comprise a radio signal level/quality of a target cell greater than a radio signal level/quality of a serving cell.

The predictive measurement configuration information may comprise an artificial intelligence/machine learning (AI/ML) model for measurement prediction.

The method 500 may comprise a step of determining 530 current radio conditions of a first target cell and a first serving cell fulfilling the one or more first triggering conditions, and a step of determining 540 predictive radio conditions of the first target and serving cells, based on the received predictive measurement configuration information, fulfilling the one or more second triggering conditions. After the determination of the current radio conditions and the predictive radio conditions respectively fulfilling the one or more first and second triggering conditions, the method 500 may comprise a step of transmitting 550, to the first target cell, information indicating a handover is executed. More particularly, in response to the determination of the current radio conditions and the predictive radio conditions respectively fulfilling the one or more first and second triggering conditions, the method 500 may comprise a step of transmitting 550, to the first target cell, information indicating a handover is executed

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method implemented in a wireless transmit/receive unit (WTRU) comprising
receiving, from a network, a first message comprising predictive measurement configuration information of radio conditions for a target cell and a serving cell;
receiving, from the network, a second message comprising handover configuration information, the handover configuration information indicating one or more first triggering conditions, related to current radio conditions, of the target cell and the serving cell, and one or more second triggering conditions, related to predicted radio conditions, of the target cell and the serving cell;
performing predictions of the radio conditions based on the predictive measurement configuration information; and
upon a determination that the current radio conditions fulfill the one or more first triggering conditions and the predicted radio conditions fulfill the one or more second triggering conditions, performing handover towards the target cell and transmitting, to the target cell, a third message comprising information indicating the handover is executed.

2. The method of claim 1, wherein the one or more first triggering conditions comprise a current radio signal level/quality of the target cell greater than a radio signal level/quality of the serving cell by more than a first threshold.

3. The method of claim 1, wherein the predictive measurement configuration information comprises information about an artificial intelligence/Machine learning, AI/ML, model for measurement prediction.

4. The method of claim 1, wherein performing predictions of the radio conditions comprises determining radio signal levels at a future time based on any of historical radio signal level measurements, a current location, and a current time.

5. The method of claim 1 comprising:
prior to receiving predictive measurement configuration information, transmitting, to the network, a fourth message comprising information indicating a measurement prediction capability of the WTRU.

6. The method of claim 5, wherein the measurement prediction capability of the WTRU comprises any of a prediction time range, a time step, and a confidence/error level.

7. (canceled)

8. The method of claim 1, wherein the predictive measurement configuration information indicates a timeline associated with predicting a radio signal level of the target cell and the serving cell.

9. The method of claim 1, comprising receiving the first message using a radio resource control message, a medium access control element, downlink control information, or broadcast signaling.

10. The method of claim 1, comprising starting the performing predictions of the radio conditions on condition that the current radio conditions of the serving cell and the target cell fulfill the one or more first triggering conditions.

11. A wireless transmit/receive unit (WTRU) comprising a processor, a transceiver unit and a storage unit, and configured to:
receive, from a network, a first message comprising predictive measurement configuration information of radio conditions for a target cell and a serving cell;
receive, from the network, a second message comprising handover configuration information, the handover configuration information indicating one or more first triggering conditions, related to current radio conditions, of the serving cell and the target cell, and one or more second triggering conditions, related to predicted radio conditions, of the target cell and the serving cell;
perform predictions of the radio conditions based on the predictive measurement configuration information; and
upon a determination that the current radio conditions fulfill the one or more first triggering conditions and the predicted radio conditions fulfill the one or more second triggering conditions, performing handover towards the target cell and transmitting, to the target cell, a third message comprising information indicating the handover is executed.

12. The WTRU of claim 11, wherein the one or more first triggering conditions comprise a current radio signal level/quality of the target cell greater than a current radio signal level/quality of the serving cell by more than a first threshold.

13. The WTRU of claim 11, wherein the predictive measurement configuration information comprises information about an artificial intelligence/Machine learning, AI/ML, model for measurement prediction.

14. The WTRU of claim 11, wherein performing predictions of the radio conditions comprises determining radio signal levels at a future time based on any of historical radio signal level measurements, a current location, and a current time.

15. The WTRU of claim 11, configured to
transmit, to the network, a fourth message comprising information indicating measurement prediction capability of the WTRU.

16. The WTRU of claim 15, wherein the measurement prediction capability of the WTRU comprises any of a prediction time range, a time step, and a confidence/error level.

17. (canceled)

18. The WTRU of claim 11, wherein the predictive measurement configuration information indicates a timeline associated with predicting a radio signal level of the target cell and the serving cell.

19. The WTRU of claim 11, configured to receive the first message using a radio resource control message, a medium access control element, downlink control information, or broadcast signaling.

20. The WTRU of claim 11, configured to start the performing predictions of the radio conditions on condition that the current radio conditions of the serving cell and the target cell fulfill the one or more first triggering conditions.

21. The method of claim 1, wherein the one or more second triggering conditions comprise a predicted radio signal level/quality of the target cell greater than a predicted radio signal level/quality of the serving cell by more than a second threshold.

22. The WTRU of claim 11, wherein the one or more second triggering conditions comprise a predicted radio signal level/quality of the target cell greater than the predicted radio signal level/quality of the serving cell by more than a second threshold.
